(19) United States
(12) Patent Application Publication
(10) Pub. No.: US 2007/0013875 A1
(43) Pub. Date: Jan. 18, 2007

(54) Projection device

(76) Inventors: Shohei Matsuoka, Tokyo (JP); Ken Agatsuma, Tokyo (JP)

Correspondence Address: PITNEY HARDIN LLP, 7 TIMES SQUARE, NEW YORK, NY, 10036-7311, US

(21) Appl. No.: 11/484,927

(22) Filed: Jul. 12, 2006

(30) Foreign Application Priority Data
Jul. 12, 2005 (JP) 2005-202794

(51) Int. Cl. G03B 21/14

(52) U.S. Cl. 353/70

(57) ABSTRACT

A projection device is provided with an image source unit, the image source, a first projecting optical system, an intermediate optical system and a second projecting optical system. Optical axes of the first and second projecting optical systems as developed are on a same plane. The image source is tilted, and then the center of the image source is translated in a direction spaced from the first projecting optical system within a plane including the image displaying area of the image source ;unit. In the above configuration, a relationship below may be satisfied:
0<S1≦(H/2)×√tanθ,

where, θ denotes an absolute value of tilt angle, S1 denotes a shift amount of the image source, H denotes a width of the image source within the same plane.

### BACKGROUND OF THE INVENTION

The present invention relates to a projection device configured to obliquely project an image formed on an image source to a screen using a trapezoidal intermediate image.

Conventionally, a projection device that obliquely projects an image displayed on an image source unit onto a screen has been known. It is noted that, in the following description, a term “projection device” represents the obliquely displaying type project device as described above.

Generally, the projection device is configured such that an image source displays an image to be projected on the screen. The image is typically a rectangular shape with a predetermined aspect ratio. Using a first optical system (image source side optical system), light carrying the image displayed by the image source is converged on an intermediate image plane. It is noted that the light is obliquely incident on the intermediate image plane, and the image formed on the intermediate image plane has a trapezoidal shape. Next, the image formed on the intermediate image plane is projected on the screen using a second optical system (a screen side optical system). The light is also incident on the screen obliquely such that the trapezoidal shape of the intermediate image is re-shaped and a rectangular image is formed on the screen.

Further, the image source, the first optical system and an intermediate image plane are arranged to satisfy Scheinpflug's law. Similarly, the intermediate image plane, the second optical system and the screen are arranged to satisfy Scheinpflug's law. With such a configuration, the image displayed on the image source unit can be displayed on the screen by obliquely incident light carrying the image with focused condition.

An example of such an projection device is disclosed in Japanese Patent Provisional Publication No. HEI 09-203881 (hereinafter, referred to as '881 publication).

In '881 publication, the first optical system is arranged such that, on the intermediate image plane, the optical axis of the first optical system is shifted with respect to the optical axis of the second optical system. With such a configuration, it becomes possible to realize a relatively large incident angle with respect to the screen without changing the configuration of the first optical system. Generally, the oblique projection type projecting device can be downsized by increasing the incident angle of light forming an image with respect to the screen. According to the teachings of '881 publication, by suppressing the deflection angle at the intermediate image plane, deterioration of the optical performance if the projection device can be suppressed. Here, the deflection angle denotes an angle formed between the optical axes of the screen side optical system and the image source side optical system at the intermediate image plane (in the description, the angle less than 90° is referred to).

According to the configuration disclosed in '881 publication, however, the deflection angle is not sufficiently reduced, and therefore, the screen side optical system is required to have a relatively high optical performance. Further, according to the '881 publication, the incident angle of light with respect to the screen, the magnification of the screen side optical system and the shifting amount of the optical axes on the intermediate image plane are correlated with each other, and thus, it is difficult to adjust the incident angle of the light with respect to the screen.

### SUMMARY OF THE INVENTION

Aspects of the invention provide a projection device which is configured that the incident angle of the light with respect to the screen of the projection device is adjustable.

According to aspects of the invention, there is provided a projection device, which is provided with an image source unit configured to emit light carrying an image, the image source unit having an image displaying area, a first projecting optical system configured to form an intermediate image carried by the light emitted by the image source unit, an intermediate optical system, and a second projecting optical system, The intermediate optical system is configured to combine a pupil of the first projecting optical system and a pupil of the second projecting optical systems, the intermediate optical system leading the light emerging from the first projecting optical system to the second projecting optical system, the second projecting optical system being configured to project light deflected by the intermediate optical system to a screen of the projection device. The image displaying area of the image source unit has a substantially similar shape of an image displaying area of the screen. Optical axes of the first projecting optical system and the second projecting optical system are on a same plane when an optical path of the projection device is developed. The image displaying area of the image source unit is tilted with respect to a plane that is perpendicular to the optical axis of the first projecting optical system with maintaining a normal to a center of the image displaying area of the image source unit being kept on the same plane. The center of the image displaying area of the image source unit may be shifted in a direction spaced from the first projecting optical system within a plane including the image displaying area of the image source unit with respect to an intersection between the optical axis of the first projecting optical system and the image displaying area of the image source unit. A relationship below is satisfied:
0<S1≦(H/2)×√tanθ,

where, θ denotes an absolute value of tilt angle, S1 denotes a shift amount of the image source unit, H denotes a width of the image source unit within the same plane.

The center of the displayed image area on the screen may be shifted in a direction spaced from the second projecting optical system with included in the same plane with respect to an intersection between the optical axis of the second projecting optical system and the screen. The image displayed area on the screen and the image displaying area of the image source unit may have a following relationship:
S2>m(S1+d)

where, d denotes a distance between the optical axes on the intermediate image plane, S2 denotes the shift amount of image displaying area of the image source unit, and m denotes a magnification of the projecting optical system.

In a particular case, the above relationship may be modified to a following relationship:
S2=m·S1.

The projection device may have an image source unit translating unit configured to shift the image source unit within a plane including the image displaying are of the image source unit.

The intermediate optical system may be provided in the vicinity of the intermediate image plane.

### BRIEF DESCRIPTION OF THE ACCOMPANYING DRAWINGS

FIG. 1 schematically shows a configuration of a projection device according to an embodiment of the invention.

FIG. 2 is an enlarged side view of a projecting optical system with the optical path being developed, according to the embodiment of the invention.

FIG. 3 shows a positional relationship among optical elements according to the embodiment of the invention.

FIG. 4 shows a chart illustrating an arrangement of an image source.

FIG. 5 shows a positional relationship between the first projecting optical system and the second projecting optical system.

FIG. 6 shows the degree of distortion of an image projected by the projection device according to the embodiment.

### DETAILED DESCRIPTION OF THE EMBODIMENTS

Hereinafter, referring to the accompanying drawings, scanning lenses according to embodiments of the invention will be described.

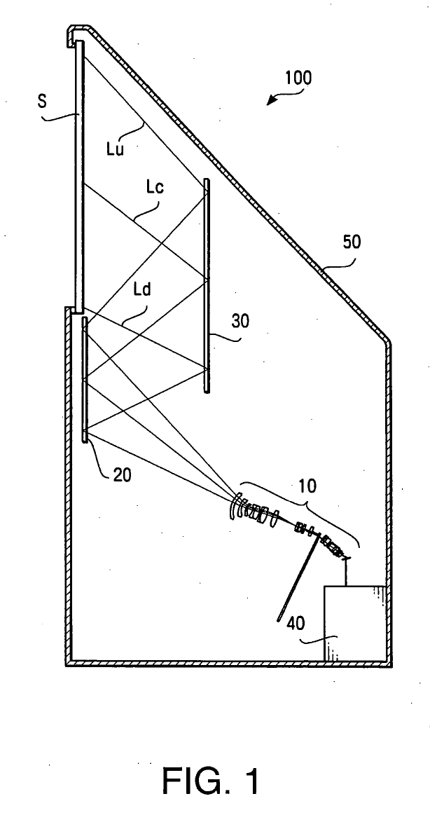

FIG. 1 schematically shows a configuration of a projection device 100 according to an embodiment of the invention. The projection device 100 has a housing 50, which accommodates a projecting optical system 10, a first mirror 20, a second mirror 30, a driving unit 40 and a screen S.

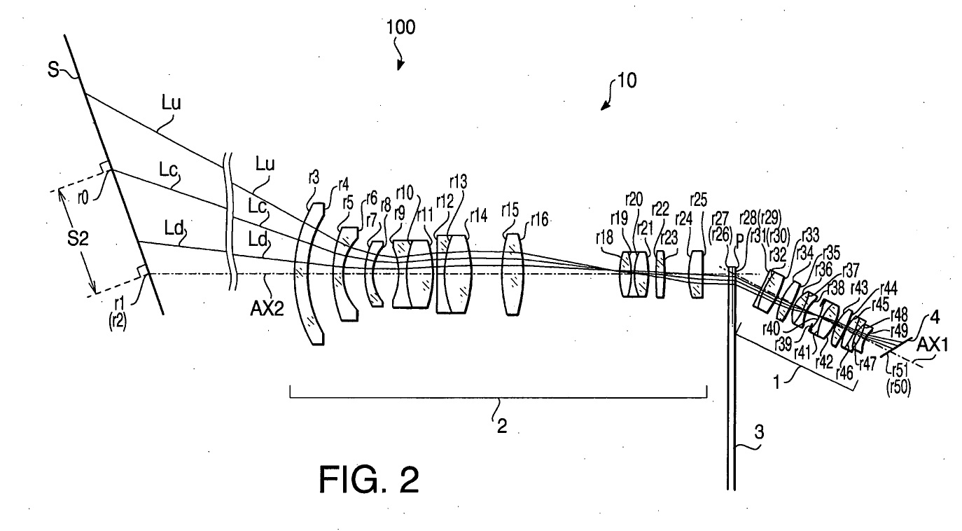

FIG. 2 is an enlarged side view of the projecting optical system 10 with the optical path thereof being developed. In FIG. 2, the first mirror 20 and the second mirror 30 are omitted for brevity. As shown in FIG. 2, the projecting optical system 10 includes a first projecting optical system 1, an intermediate optical system (in the embodiment, a deflecting optical system, e.g., Fresnel lens) 3, a second projecting optical system 2, and an image source 4.

In FIG. 2, AX1 denotes an optical axis of the first projecting optical system 1, and AX2 denotes an optical axis of the second projecting optical system 2. In FIG. 2, the optical axes AX1 and AX2 are indicated by dotted lines. FIG. 2 is, therefore, a cross sectional view of the projecting optical system 10 taken along a plane including the optical axes AX1 and AX2. It should be noted that the plane including the optical axes AX1 and AX2 divides the screen S substantially evenly along a vertical line passing the center of the screen S. In the following description, the plane including the optical axes AX1 and AX2 will be referred to as a reference plane.

In the projection device 100, the lenses and/or part of optical surfaces of each of the optical systems 1 and 2 are shifted with each other in order to compensate for aberration and/or distortion that cannot be compensated for by rotationally symmetrical optical systems. Thus, in the following description, in each projecting optical systems 1 and 2, a line mostly coincides with the central axis of contained optical surfaces will be defined as an optical axis thereof. If all the central axes are shifted from each other, a line coincides with the central axis of the optical surface closest to a pupil will be defined as the optical axis of the optical system.

In the actual projection device 100, depending on the positional relationship among the optical elements, further mirrors may be provided, in addition to the first and second mirrors 20 and 30, to bend the optical path inside the projection optical system 10. In the following description, however, each element will be illustrated with developing the optical axis (i.e., assuming that all the optical elements are arranged on the reference plane).

The image source 4 displays an image to be expanded and projected on the screen S. When the image source 4 is located at a predetermined position inside the projection device 1, an image display surface is referred to. In the following description, however, the image source 4 and the image display surface thereof will not be distinguished for brevity. The light emitted by the image source 4 carrying the image passes through the first projecting optical system 1 and forms an intermediate image on an intermediate image plane P. The Fresnel lens 3 is arranged in the vicinity of the image plane P. The Fresnel lens 3 deflects the light forming the intermediate image and directs the same to the second projecting optical system 2. The second projecting optical system 2 diverges the light that enters via the intermediate optical system 3. The diverging light emerged from the second projecting optical system 2 (i.e., the projecting optical system 10) is reflected by the first mirror 20 and second mirror 30 in this order, and obliquely incident on the screen S from behind (i.e., on an inner surface of the screen S). With this configuration, the image displayed on the image source 4 is projected on the screen S as an enlarged image.

In FIGS. 1 and 2, a ray, on the reference plane, corresponding to the upper end of the image projected on the screen S is referred to as a ray Lu, a ray, on the reference plane, corresponding to the center of the image projected on the screen S is referred to as a ray Lc, and a ray, on the reference plane, corresponding to the lower end of the image projected on the screen S is referred to as a ray Ld. It is noted that, in the following description, an upper end of the image and lower end of the image correspond to the upper and lower ends of the image on the reference plane, respectively.

On the inner surface of the screen S, a thin-film type Fresnel lens (not shown) is adhered so that the rays obliquely incident on the inner surface of the screen S emerge from the front surface (i.e., from the viewer side) substantially perpendicular to the surface of the screen S.

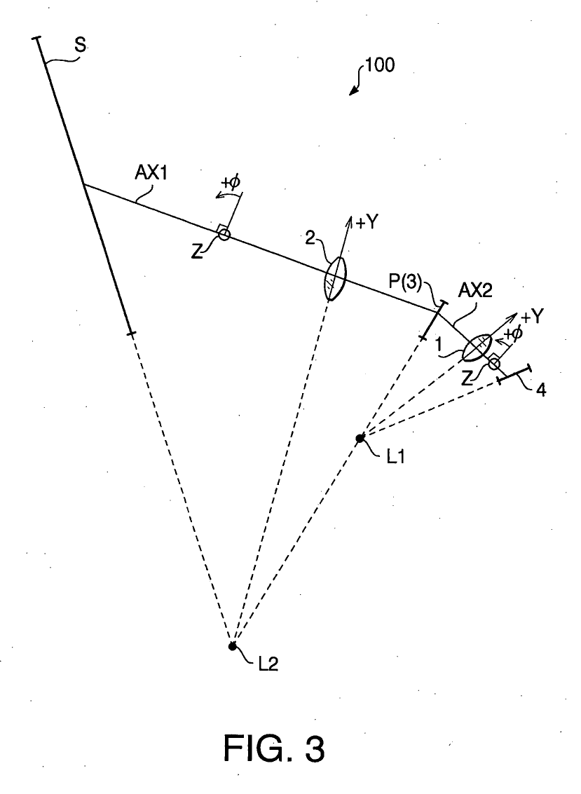

FIG. 3 shows a positional relationship of the screen S and elements of the projecting optical system 10. In FIG. 3, for the sake of simplified explanation, each of the projecting optical systems 1 and 2 is represented by a single lens. In the projection device 100, the image source 4, the first projecting optical system 1 and the image plane P of the intermediate image are inclined with each other according to the Scheinpflug's law. That is, extended planes of the image source 4, a principal plane of the first projecting optical system 1 and the image plane P intersect at the same line (hereinafter, referred to as a first reference line) L1.

In addition to the above, the screen S, the second projecting optical system 2 and the image plane P (the intermediate optical system 3) are arranged in accordance with Scheinpflug's law. That is, extended planes of the screen S, a principal plane of the second projecting optical system 2, and the image plane P intersect with each other on the same line L2, which will be referred to as a second reference line L2.

With the above configuration, the light from the image source 4, which carries the image to be displayed, forms the intermediate image via the first projecting optical system 1. The intermediate image contains the trapezoidal distortion. The light forming the intermediate image further proceeds, and, via the second projecting optical system 2, an enlarged image corresponding to the image displayed by the image source 4 is projected on the screen S. Because of the arrangement of respective optical elements, trapezoidal distortion of opposite direction is applied when the intermediate image is projected on the screen S, thereby the distortion being cancelled. Thus, the viewer can observe the enlarged image which does not contain the trapezoidal distortion.

Next, an arrangement of the projection optical system 10 and the screen S will be described in detail.

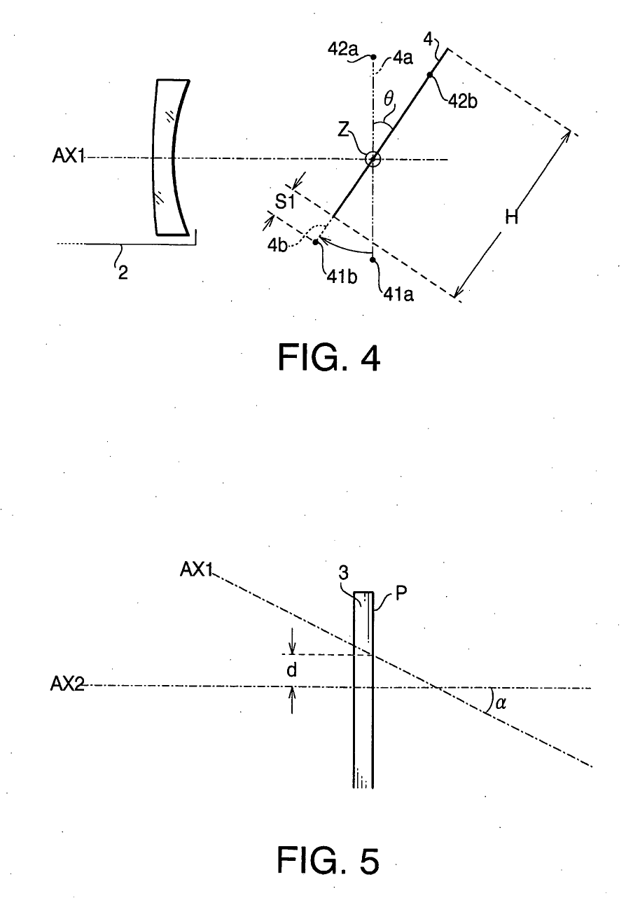

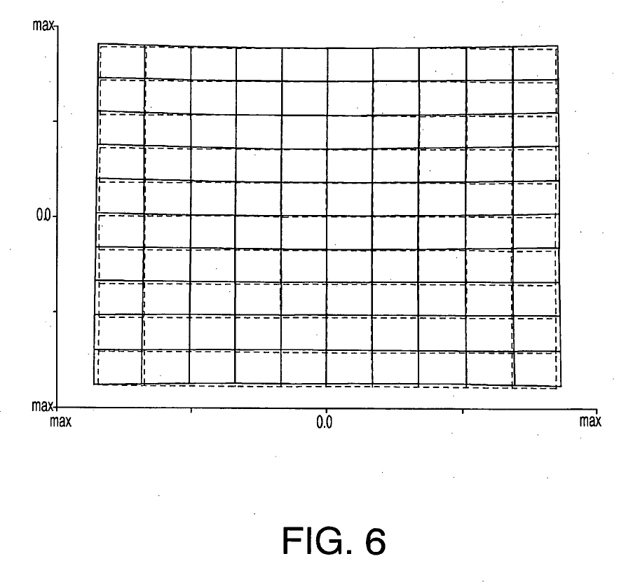

First, an arrangement of the image source 4 will be described referring to FIG. 4. The image source 4 (i.e., the image displaying surface thereof) should satisfy, together with the first projecting optical system 1 and the intermediate image plane P (or Fresnel lens 3), the Scheinpflug's law. Specifically, the image source 4 is tilted with respect to a line perpendicular to the optical axis AX1 of the first projecting optical system 1 about an axis Z (see FIG. 4), wherein the axis Z is an axis perpendicular to a plane of FIG. 4. In FIG. 4, the image source 4a not being tilted is indicated by a two-dotted line, and the tilted image source 4b is illustrated with a broken line (partially overlapping). In other words, the image source 4 is inclined with respect to a plane perpendicular to the optical axis AX1 with the normal to the center of the image source 4 being kept on the reference surface (i.e., a plane of FIG. 4).

It is understood by comparing the image source as tilted (4b) with the image source as not-tilted (4a), an end portion 41b of the image source 4b has been moved closer to the first projecting optical system 1 than an end portion 41a of the image source 4a having not been moved. Similarly, an end portion 42b of the image source 4b has been moved farther from the first projecting optical system 1 than an end portion 42a of the image source 4a having not been moved. As understood from FIG. 4, a ray from the end portion 41b to the center of the most image source side surface of the first projecting optical system 1 is greater than a ray from the end portion 41a to center of the most image source side surface of the first projecting optical system 1. That is, an angle of view of the first projecting optical system 1 greater for the mirror when tilted than when not tilted. In other words, by titling the mirror 4 as shown in FIG. 4, a higher optical performance of the projecting optical system 1 is required.

According to the embodiment, in order to handle the above problem, the image source 4b as tilted is translated (parallelly moved) on the same plane itself in the direction where the center of the image source 4 is away from the first projecting optical system (i.e., upper right-hand side in FIG. 4). The image source 4 as moved is indicated by a solid line in FIG. 4.With this translation, the closer end portion of the tilted image source is not located too close to the first projecting optical system 1, and the requirement imposed to the first projecting optical system (i.e., the optical performance: in particular, the performance in terms of the angle of view) is alleviated.

Specifically, given that an absolute value of tilt angle (with respect to a plane perpendicular to the optical axis AX1) is represented by θ, a shift amount of the image source 4 along its image surface is S1 (in FIG. 4, represented by a shift amount of the end portion 41b), a width of the image source in a direction perpendicular to the Z axis is represented by H, the image source 4 is arranged to satisfy condition (1) below.
0<S1≦(H/2)×√tanθ (1)

If the shift amount S1 is out of the range of condition (1), an incident angle of a ray directed from one of the end portions, in the direction perpendicular to the Z axis, of the image source 4 with respect to the first projecting optical system 1 is too large. That is, in such a state, the projecting optical system 1 is required to have a higher optical performance in terms of the angle of view. Such a state should preferably be avoided.

By setting the shifting amount S1 so as to satisfy condition (1), the incident angle of the rays can be suppressed at relatively small angles. Thus, when condition (1) is satisfied, the optical performance of the first projecting optical system 1 need not be enhanced, and still the required optical performance of the project display device 100 as a whole can be achieved. In addition, with the configuration of the first projecting optical system 1 above, the image height of the intermediate image can also be suppressed. Therefore, the second projecting optical system 2 need not be configured to have a relatively larger angle of view.

Next, a positional relationship among the screen S, the second projecting optical system 2 and the first projecting optical system 1 will be described referring to FIGS. 2 and 5. Similar to the image source 4 described above, the screen S is translated such that the center of the image projection area of the screen S is shifted from the optical axis AX2, within a plane of the screen S, in a direction where the center is away from the second projecting optical system 2 (i.e., in an upper left-hand side direction in FIG. 2). In FIG. 2, the shifted amount is indicated by S2. By configuring the projection display device 100 such that both the image source 4 and screen S are translated, the deflection angel α formed between the optical axes AX1 and AX2 can be made smaller.

Further, as shown in FIG. 5, the optical axes AX1 and AX2 can be shifted on the intermediate image plane P. Given that the shift amount of the optical axes AX1 and AX2 on the intermediate image plane P is represented by d, the projection magnification of the projecting optical system 10 is represented by m, the shift amount S1 of the image source 4 and the shift amount S2 (see FIG. 2) of the screen S satisfy the following relationship (2).
S2≧m(S1+d) (2)

If the shift amount d equals zero, that is, if the optical axes AX1 and AX2 intersect on the intermediate image plane P, relationship (2) is written as follows.
S2=m·S1

When the relationship (2) is satisfied, it is possible that the incident angle of the light emitted by the second projecting optical system 2 and incident on the screen S can be made larger.

It should be noted that, according to the embodiment, the image source 4 is configured to be translated by a driving unit 40. Specifically, the driving unit 40 translates (moves) the image source 4 automatically or in accordance with externally input instructions so that the light is incident on the screen S at a predetermined incident angle. By employing the driving unit 40, the user can change the incident angle.

Next, a concrete configuration of the projection display device 100 according to the embodiment will be described.

TABLE 1 shows numerical examples of the projection device 100. In TABLE 1, the tilt angle φ (unit: degrees) of each element represents a tilted amount with respect to a plane perpendicular to both optical axes AX1 and AX2. The tilted amount is measured such that a counterclockwise direction in FIGS. 1-5 represents a positive value. The shift amounts Y of each element in TABLE 1 represents a shifted amount of each element with respect to the optical axis with maintaining the tilted amount. The shift amount Y is measured such that a direction away from the first reference line L1 and the second reference line L2 represents a positive value.

TABLE 1

| | | | | | | | ROTATIONALLY | | |
|---|---|---|---|---|---|---|---|---|---|
| | | | | | | | SYMMETRICAL | | |
| | | | | | | | ASPHERICAL | | |
| | | | | | | | SURFACE | | |
| | | | | | | | COEFFICIENT | | |
| | RADIUS OF | | REFRACTIVE | ABBE's | TILT | SHIFT | 4th | 6th | |
| No. | CURVATURE | DISTANCE | INDEX (nd) | NUMBER (vd) | ANGLE φ | AMOUNT Y | DEGREE | DEGREE | DESCRIPTION |
| 0 | INFINITY | 0.00 | | | | | | | SCREEN S |
| 1 | INFINITY | 0.00 | | | | −342.00 | | | |
| 2 | INFINITY | 800.00 | | | −20.00 | | | | |
| 3 | 60.86 | 4.80 | 1.492 | 57.40 | | | 3.944E−06 | −5.476E−10 | SECOND |
| 4 | 35.94 | 9.80 | | | | | −3.904E−06 | −3.504E−09 | PROJECTING |
| 5 | 46.77 | 3.40 | 1.773 | 49.60 | | | | | OPTICAL |
| 6 | 17.59 | 8.37 | | | | | | | SYSTEM 2 |
| 7 | 25.61 | 2.90 | 1.697 | 55.53 | | | | | |
| 8 | 14.32 | 9.89 | | | | | | | |
| 9 | −21.44 | 2.90 | 1.835 | 42.71 | | | | | |
| 10 | 37.36 | 9.70 | 1.620 | 36.26 | | | | | |
| 11 | −37.67 | 1.59 | | | | | | | |
| 12 | 1945.98 | 2.92 | 1.847 | 23.78 | | | | | |
| 13 | 40.31 | 9.74 | 1.620 | 36.26 | | | | | |
| 14 | −41.88 | 11.43 | | | | | | | |
| 15 | 65.85 | 7.79 | 1.620 | 36.26 | | | | | |
| 16 | −55.05 | 26.42 | | | | | | | |
| 17 | 0.00 | 9.86 | | | | | | | |
| 18 | 29.08 | 4.31 | 1.488 | 70.24 | | | | | |
| 19 | −24.78 | 1.00 | 1.805 | 25.43 | | | | | |
| 20 | 19.86 | 5.00 | 1.488 | 70.24 | | | | | |
| 21 | −33.30 | 3.10 | | | | | | | |
| 22 | 158.06 | 2.69 | 1.488 | 70.24 | | | | | |
| 23 | −119.95 | 9.43 | | | | | | | |
| 24 | 25.83 | 5.00 | 1.847 | 23.78 | | | | | |
| 25 | INFINITY | 10.77 | | | | | | | |
| 26 | INFINITY | 0.00 | | | −3.49 | | | | INTERMEDIATE |
| 27 | 0.00 | 2.00 | 1.492 | 57.40 | | −90.53 | | | OPTICAL |
| 28 | −138.05 | 0.00 | | | | | 5.014E−08 | | SYSTEM 3 |
| 29 | INFINITY | 0.00 | | | | 90.53 | | | |
| 30 | INFINITY | 9.52 | | | −23.71 | | | | NGOPTI |
| 31 | −981.05 | 1.00 | 1.847 | 23.78 | | | | | |
| 32 | 26.84 | 5.30 | 1.801 | 34.97 | | | | | |
| 33 | −33.36 | 2.51 | | | | | | | |
| 34 | 21.35 | 3.77 | 1.834 | 37.16 | | | −3.611E−05 | | |
| 35 | −71.61 | 1.12 | | | | | −1.552E−05 | | |
| 36 | 9.72 | 3.84 | 1.603 | 60.64 | | | | | |
| 37 | −17.85 | 0.80 | 1.847 | 23.78 | | | | | |
| 38 | 7.96 | 4.51 | | | | | | | |
| 39 | INFINITY | 1.03 | | | | | | | |
| 40 | −9.57 | 1.00 | 1.620 | 36.26 | | | | | |
| 41 | 17.50 | 5.00 | 1.834 | 37.16 | | | | | |
| 42 | −12.83 | 0.50 | | | | | −4.569E−05 | | |
| 43 | 13.27 | 3.73 | 1.834 | 37.16 | | | 6.368E−05 | | |
| 44 | −42.49 | 0.50 | | | | | | | |
| 45 | 20.34 | 3.00 | 1.603 | 60.64 | | | | | |
| 46 | −34.44 | 1.00 | 1.847 | 23.78 | | | | | |
| 47 | 11.21 | 1.69 | | | | | | | |
| 48 | −98.08 | 2.00 | 1.492 | 57.40 | | | | | |
| 49 | 12.16 | 1.07 | | | | | | | |
| 50 | INFINITY | 0.00 | | | −32.02 | | | | |
| 51 | INFINITY | 0.00 | | | | 3.28 | | | IMAGE |
| | | | | | | | | | SOURCE 4 |

In TABLE 1, surface numbers #0-#2 represent the screen S. Surfaces #3-#25 represent the second projecting optical system 2. Surfaces #26-#29 represent the intermediate optical system (Fresnel lens) 3, and surfaces #30-#50 represent the first projecting optical system 1. Surface #51 represents the image source 4.

Surface #0 is referred to as a reference position of the screen S, surface #1 represents a surface obtained by shifting the surface #0, within a plane including the screen, by −342.00 (mm), and surface #2 represents a surface obtained by titling the surface #1 by −20.00°. That is, the screen S according to the embodiment is, with respect to a screen whose center coincides with the optical axis AX2, tilted by +20.00°, and shifted by +342.00 mm in the direction described above.

By ray tracing, the shift amount d and the magnification m are obtained as follows:
d=0.27 mm, and
m=86.

Hereinafter, a term decentering defining surface will be introduced. The decentering defining surface is a surface that is referred to when defining a decentering state, such as surfaces #1 and #2. It should be noted that a coordinate system following the decentering defining surface represents a relative coordinate system that is defined with respect to the decentering defining surface.

As indicated in TABLE 1, surfaces #3, #4, #28, #34, #35, #42 and #43 are rotationally symmetrical aspherical surfaces. Generally, a shape of the aspherical surface is expressed by a sag amount which is a distance from a tangential plane to the aspherical surface at the optical axis thereof. Specifically, given that the sag at a point whose height from the rotational axis is h is indicated as X(h), the curvature (1/r) of the aspherical surface on the optical axis (i.e., rotational axis) is C, a conical coefficient is K, and aspherical surface coefficients are A₄, A₆, . . . , the sag X(h) is expressed by formula (3) below.

$$X ( h ) = \frac{{Ch}^{2}}{1 + \sqrt{1 - ( K + 1 ) {C}^{2} {h}^{2}}} + {A}_{4} {h}^{4} + {A}_{6} {h}^{6} + … \qquad ( 3 )$$

It should be noted that in the expression of the aspherical coefficients, each value in TABLE 1 represents a radix number, and a number on the right-hand side of “E” represents a power. In the embodiment, the conical coefficient K and aspherical coefficients for degrees that are not indicated herein are zero.

It is assumed that the image source 4 is configured such that the height H is 10.92 mm, a length in a direction perpendicular to the height H (i.e., the Z axis direction) is 19.38 mm. Using these values and values indicated in TABLE 1,
S1=3.28, and
(H/2)×√tanθ=(10.92/2)×√tan32.02°=4.21
Therefore, relationship (1) is satisfied (3.28≦4.21). By shifting the image source 4 by amount S1 (=3.28) with satisfying relationship (1), the angle of view is changed from 27.8° to 23.7°. That is, a requirement imposed to the first projecting optical system can be loosened.

By substituting the values of d=0.27 mm, m=86, S1=3.28 and S2=342 as described above, it is known that relationship (2) is satisfied. That is:
S2(=342)≧86×(3.28+0.27)=305

When the projecting optical systems 1 and 2 have been shifted with satisfying relationship (2), the incident angle with respect to the screen S is changed from 36° to 480°. Thus, the projection display device 100 can be downsized, in particular, the depth can be reduced significantly.

Further, by satisfying relationships (1) and (2), the deflection angle at the intermediate image plane P is changed from 25.4° to 24.1°. Thus, the arrangement of the projecting optical systems 1 and 2 is closer to a linear arrangement and a high-qualified image can be projected on the screen S.

It is also know by ray tracing using the values indicated in TABLE 1, the area of the intermediate image can be calculated. As relationships (1) and (2) are satisfied, the area is reduced from 40.52 mm² to 26.26 mm². Therefore, the angle of view and/or a radius of the optical elements of the second projecting optical system 2 can be suppressed to small values.

It should be note that the invention should not be limited to the configuration described above, and various modification can be derived without departing from the aspects of the invention. For example, the embodiment employs Fresnel lens as the intermediate optical system. However, this can be replaced with another structure such as one composed of three triangular prisms and the like.

Further, it may be possible that the intermediate image may not be sufficiently focused on the intermediate image plane. In other words, the functions of the first projecting optical system and the second projecting optical system need not be divided precisely. Further, the optical elements may be arranged so as not to exactly follow Scheinpflug's law.

The present disclosure relates to the subject matter contained in Japanese Patent Application No. 2005-202794, filed on Jul. 12, 2005, which is expressly incorporated herein by reference in its entirety.

What is claimed is:

1. A projection device, comprising:
an image source unit configured to emit light carrying an image, the image source unit having an image displaying area;
a first projecting optical system configured to form an intermediate image carried by the light emitted by the image source unit;
an intermediate optical system;
a second projecting optical system;
the intermediate optical system combining a pupil of the first projecting optical system and a pupil of the second projecting optical systems, the intermediate optical system leading the light emerging from the first projecting optical system to the second projecting optical system, the second projecting optical system being configured to project light deflected by the intermediate optical system to a screen of the projection device,
wherein the image displaying area of the image source unit has a substantially similar shape of an image displaying area of the screen,
wherein optical axes of the first projecting optical system and the second projecting optical system are on a same plane when an optical path of the projection device is developed,
wherein the image displaying area of the image source unit is tilted with respect to a plane that is perpendicular to the optical axis of the first projecting optical system with maintaining a normal to a center of the image displaying area of the image source unit being kept on the same plane,
wherein the center of the image displaying area of the image source unit is shifted in a direction spaced from the first projecting optical system within a plane including the image displaying area of the image source unit with respect to an intersection between the optical axis of the first projecting optical system and the image displaying area of the image source unit,
wherein a relationship below is satisfied:
0<S1≦(H/2)×√tanθ,
where, θ denotes an absolute value of tilt angle, S1 denotes a shift amount of the image source unit, H denotes a width of the image source unit within the same plane.

2. The projection device according to claim 1,
wherein the center of the displayed image area on the screen is shifted in a direction spaced from the second projecting optical system with included in the same plane with respect to an intersection between the optical axis of the second projecting optical system and the screen,
wherein the image displayed area on the screen and the image displaying area of the image source unit have a following relationship:
S2≧m(S1+d)
where, d denotes a distance between the optical axes on the intermediate image plane, S2 denotes the shift amount of image displaying area of the image source unit, and m denotes a magnification of the projecting optical system.

3. The projection device according to claim 2,
wherein, S2=m·S1.

4. The projection device according to claim 1,
further comprising an image source unit translating unit configured to shift the image source unit within a plane including the image displaying are of the image source unit.

5. The projection device according to claim 1,
wherein the intermediate optical system is provided in the vicinity of the intermediate image plane.
